(19) United States
(12) Patent Application Publication
(10) Pub. No.: US 2008/0119288 A1
(43) Pub. Date: May 22, 2008

(54) Lighting Arrrangement for a Gaming Machine

(76) Inventor: James M. Rasmussen, Chicago, IL (US)

Correspondence Address: NIXON PEABODY LLP, 161 N CLARK ST., 48TH FLOOR, CHICAGO, IL, 60601-3213, US

(21) Appl. No.: 11/664,035

(22) PCT Filed: Sep. 2, 2005
(86) PCT No.: PCT/US05/31862

§ 371 Date: Mar. 28, 2007

Related U.S. Application Data
(60) Provisional application No. 60/613,776, filed on Sep. 28, 2004.

(51) Int. Cl. A63F 13/00

(52) U.S. Cl. 463/46

(57) ABSTRACT

A lighting arrangement for a wagering game machine comprises a panel (38) including an edge and a lamp for transmitting light through at least a portion of the panel via the edge. The lamp is mounted to a bracket in proximity to the edge of the panel. The lamp and the bracket are free of physical connection to the panel such that the panel can be removed from the game machine without disconnecting the panel from the lamp or the bracket.

### FIELD OF THE INVENTION

The present invention relates generally to gaming machines and, more specifically, to a lighting arrangement for a gaming machine.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Players also appreciate the reliability of a gaming machine, as do the casino operators. Shrewd operators consequently strive to employ the most entertaining, exciting, and reliable machines available because such machines attract frequent play and hence increase profitability to the operator.

Historically, gaming machines presented a single game and top box display. To alter game offerings, casino operators needed to replace the entire gaming machine (or the entire top box display). If the operator wanted to relocate a machine to a different position on the casino floor, the entire machine would have to be moved. Replacement and relocation processes are slow and counter-productive to maintaining pace with the continuously changing gambling industry. To better serve their customers, casino operators need a method of converting and/or moving games quickly.

Another aspect of the difficulty in modifying or changing games relates directly to the service personnel responsible for the conversion. In many cases, a conversion of a gaming machine would require the replacement of the top box display and marquee. This typically requires the services of at least two service technicians to manage the weight of the top box. The difficulty of shipping and storing a large and heavy top box display in itself is cost-prohibitive. Requiring two technicians to remove one top box display and replace it with another is also costly.

Gaming Machine manufacturers, especially those that produce video-based gaming machines, have responded quickly to this need. One such response is the development of a plain gaming terminal that allows multiple games to be presented on the same machine. This method addresses the issue of offering more games and placing them at optimal locations during peak playing times, and also addresses the issue of converting games to the latest offerings by the gaming machine manufacturer (by performing a software conversion).

What is not addressed is the ability to transition the top box display easily when a conversion to a new game occurs. For example, if a casino operator decides that a certain video reel slot game, using a particular top box display, has reached the end of its playing life on the casino floor, the operator contacts the manufacturer and requests a conversion of the gaming machine to a newer, perhaps more popular game. While the conversion of the main video-based reel slot game is a simple software and surface artwork change, the top box display area can require a complete replacement. This can be time-consuming, expensive, and cumbersome.

This issue is also indicative of top box failures and the method of repair. Should a failure occur in a top box display, the typical response is to send an entire, functional top box to the casino, remove the failed top box, and return the failed top box to the service office to diagnose the problem. Again, this method requires the services of two or more technicians.

Another aspect of maintaining top box displays is the necessity to address the backlighting apparatus when servicing a top box. Many backlit top box displays offered in the industry today use a fluorescent lamp directly behind an artwork display for illumination. In order for a technician to maneuver within the top box, often times the lamp must be removed or is in danger of being touched which can result in injury if the lamp is hot. This type of top box configuration also limits the type of display that can be developed due to the need for the lamp to reside directly behind the artwork. For variations to the display, a completely different design is required which can be time consuming and expensive to develop.

To make top box conversions and repairs faster, easier, and more cost effective, the use of a common light panel display in accordance with the present invention would standardize top box artwork components, simplify the top box assembly and conversion process, and allow easier access to the top box enclosure.

### SUMMARY OF THE INVENTION

In accordance with one embodiment of the present invention, a lighting arrangement for a wagering game machine comprises a panel including an edge and a lamp for transmitting light through at least a portion of the panel via the edge. The lamp is mounted to a bracket in proximity to the edge of the panel. The lamp and the bracket are free of physical connection to the panel such that the panel can be removed from the game machine without disconnecting the panel from the lamp or the bracket. This lighting arrangement makes it more cost effective to develop new displays for top boxes, for example, and makes development and changes during game conversions quicker, easier, and more predictable.

### BRIEF DESCRIPTION OF THE DRAWINGS

The foregoing and other advantages of the invention will become apparent upon reading the following detailed description and upon reference to the drawings in which:

FIG. 1 is a perspective view of a gaming machine with a lighting arrangement in accordance with the present invention;

FIG. 2 is a block diagram of a control system suitable for operating the gaming machine;

FIG. 3 is a perspective view of a top box assembly containing the lighting arrangement;

FIG. 4 is an exploded perspective view of a glass panel, art film, and light panel of the top box assembly;

FIG. 5a is an exploded perspective view of the top box assembly;

FIG. 5b is a top cutaway view showing the placement of the glass panel, light panel, and lamp within a mounting system; and

FIG. 6 is an exploded perspective view of the top box assembly showing an alternative orientation of the lamp.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

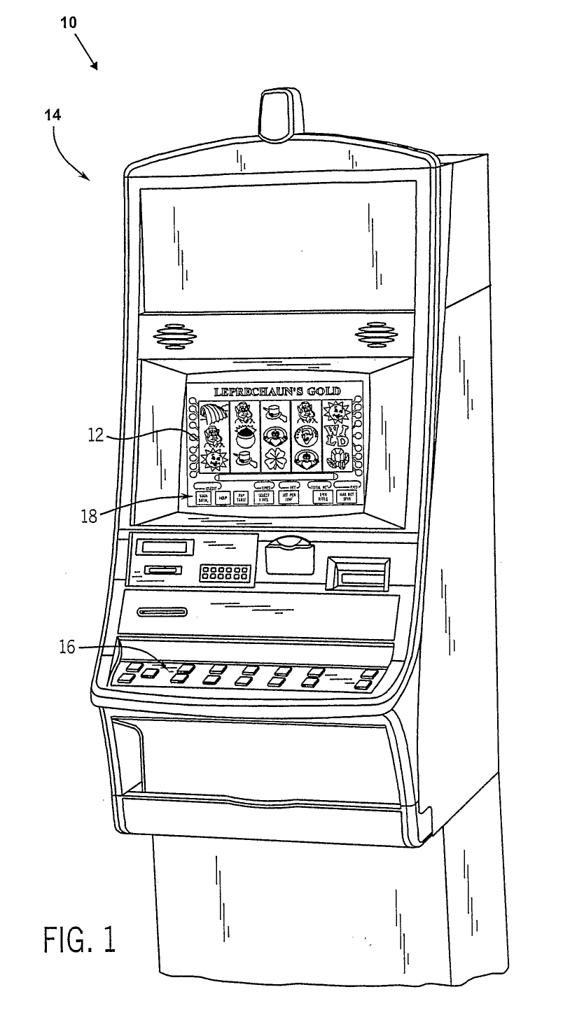

FIG. 1 depicts a gaming machine 10 operable to conduct a slot-based wagering game. In operation, the gaming machine receives a wager from a player to purchase a “play” of the game. In a “play” of the game, the gaming machine generates at least one random event and provides an award to the player for a winning outcome of the random event. The random event may be internally or remotely determined using a random number generator or pooling schema. To portray the random event and outcome to the player, the gaming machine includes a primary display 12. If the wagering game is a reel slot game, for example, the primary display 12 includes a plurality of symbol-bearing reels that are rotated and stopped to place symbols on the reels in visual association with the pay line. The game could also include games such as poker, keno, blackjack, roulette or any other electronic wagering game.

The primary display 12 may be implemented with a CRT, LCD, plasma, mechanical reels (in the case of a reel slot game), or other type of display known in the art. The primary display 12, especially if implemented in video, may be overlaid with a touch screen to facilitate interaction with the player. In the illustrated embodiment, the gaming machine 10 is an “upright” version in which the primary display 12 is oriented vertically relative to the player. Alternatively, the gaming machine may be a “slant-top” version in which the primary display 12 is slanted at about a thirty-degree angle toward the player of the gaming machine 10.

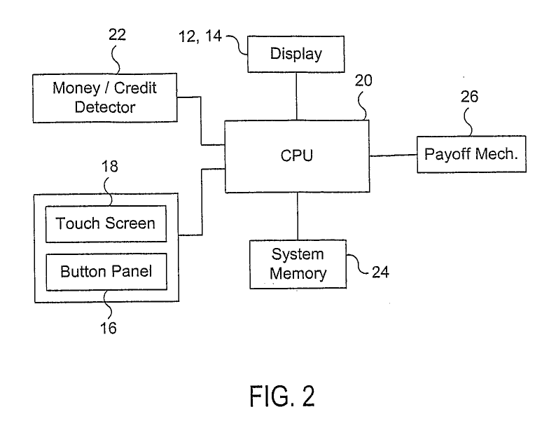

FIG. 2 is a block diagram of a control system suitable for operating the gaming machine. Money/credit detector 22 signals a central processing unit (CPU) 20 when a player has inserted money or played a number of credits. Using a button panel 16 and/or a touch screen 18 (also see FIG. 1), the player may select any variables associated with the wagering game and place his/her wager to purchase a play of the game. In a play of the game, the CPU 20 generates at least one random event using a random number generator (RNG) and provides an award to the player for a winning outcome of the random event. Alternatively, the random event may be generated by a remote computer using an RNG or pooling schema and then transmitted to the gaming machine. The CPU 20 operates the display 12 to represent the random event(s) and outcome(s) in a visual form that can be understood by the player. In addition to the CPU 20, the control system may include one or more additional slave control units for operating the display 12 and any secondary displays.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure. In fact, the system memory 24 may be located locally or remotely over a network. A payoff mechanism 26 is operable in response to instructions from the CPU 20 to award a payoff to the player. The payoff may, for example, be in the form of a number of credits. The number of credits is determined by one or more math tables stored in the system memory 24.

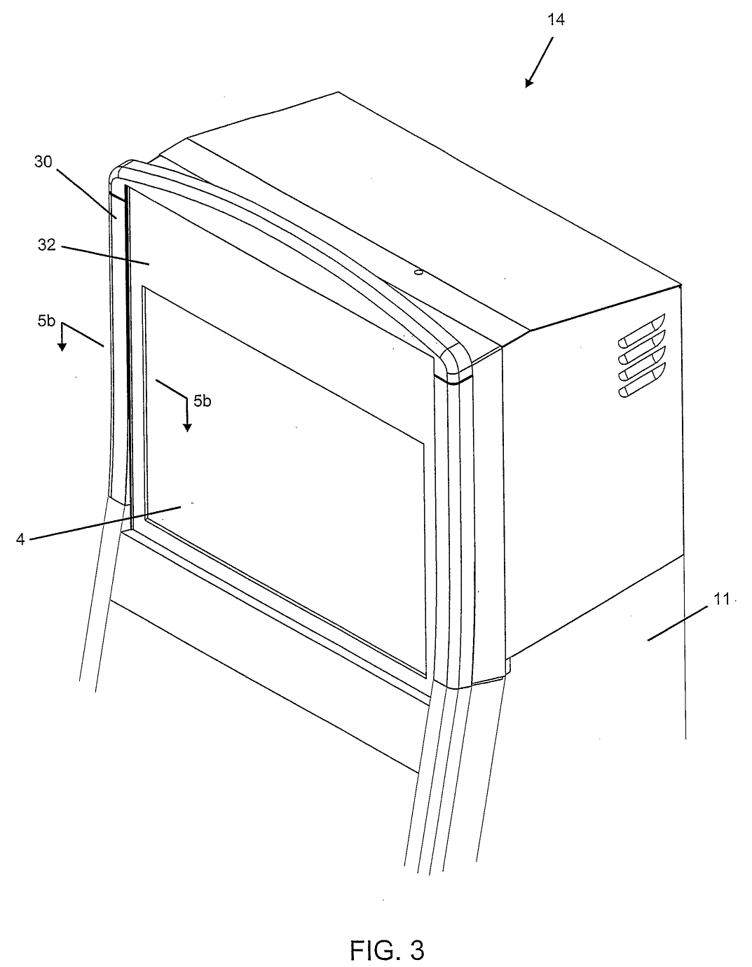

FIG. 3 is a perspective view of the top box assembly 14 of the gaming machine depicted in FIG. 1. In this general depiction, the top box assembly 14 is coupled to the cabinet 11. The face of the top box assembly 14 is a display area comprised of a display glass 32 front having adjacent artwork film or artwork screened on its surface. The artwork surrounds a viewing window 34. A crown 34 “frames” the display area.

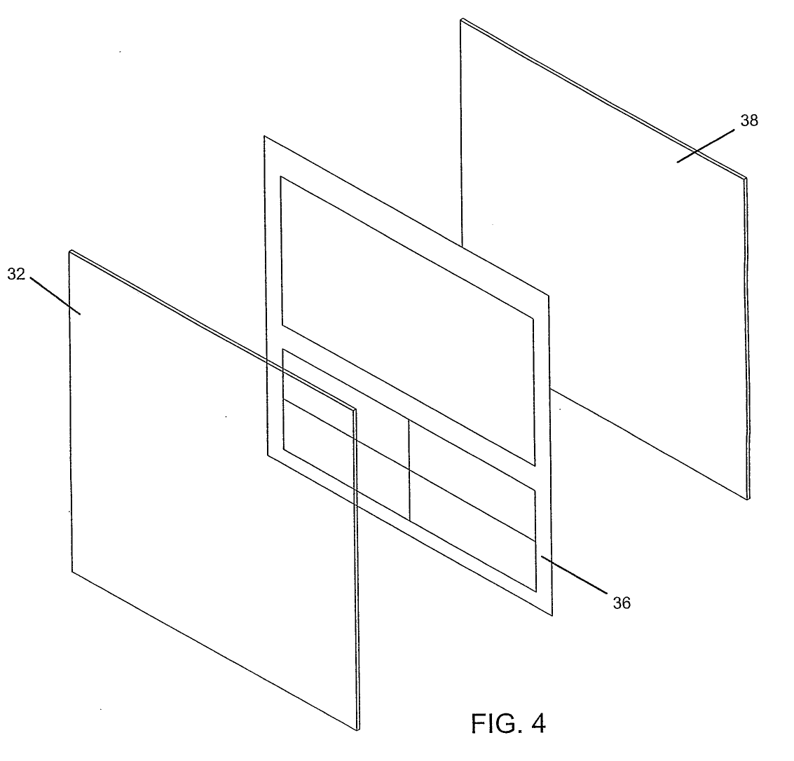

FIG. 4 is an exploded perspective view of three of the components comprising the top box light panel display and showing the respective positions of the components. In this example, the display glass 32 is clear allowing the art film 36, positioned inside and adjacent to the display glass 32, to be easily viewed. The display glass can be manufactured from, but is not limited to, a variety of materials such as glass, acrylic, polycarbonate, and other clear materials. A light panel 38 is positioned behind the art film 36 providing backlighting to display the artwork on the art film 36. The light panel 38 is manufactured with an edge allowing light from a light source to penetrate the interior of the light panel. The light panel 38 can be manufactured from a variety of materials that, with or without a reflective backing, provide a consistent dispersion of light across its surface. These materials include, but are not limited to acrylic, glass, and polycarbonates. The light panel 38 may also be manufactured from an epoxy embedded with light scattering material. The light scattering material 38 is a solid that emits light across its entire viewable surface, in a uniform, consistent fashion. It is backed with a non-translucent material that prevents light from penetrating it such as non-transparent plastic, sheet metal, or other materials. Further information regarding light scattering material and methods of reflecting and dispersing light is disclosed in U.S. Pat. No. 6,592,238 Cleaver, et al, and U.S. Patent Application No. 60/572,615 to Kopera, et al, filed on May 19, 2004 and entitled “Gaming Machine with Light Altering Features,” both which are incorporated herein by reference in their entirety.

If a reflective backing is used on the light panel 38, it can be any of the following materials (but not limited to): reflective paint, foil, surface etching that changes the index of reflection, sheet metals, and reflective plastics such as polyethylene or polyester.

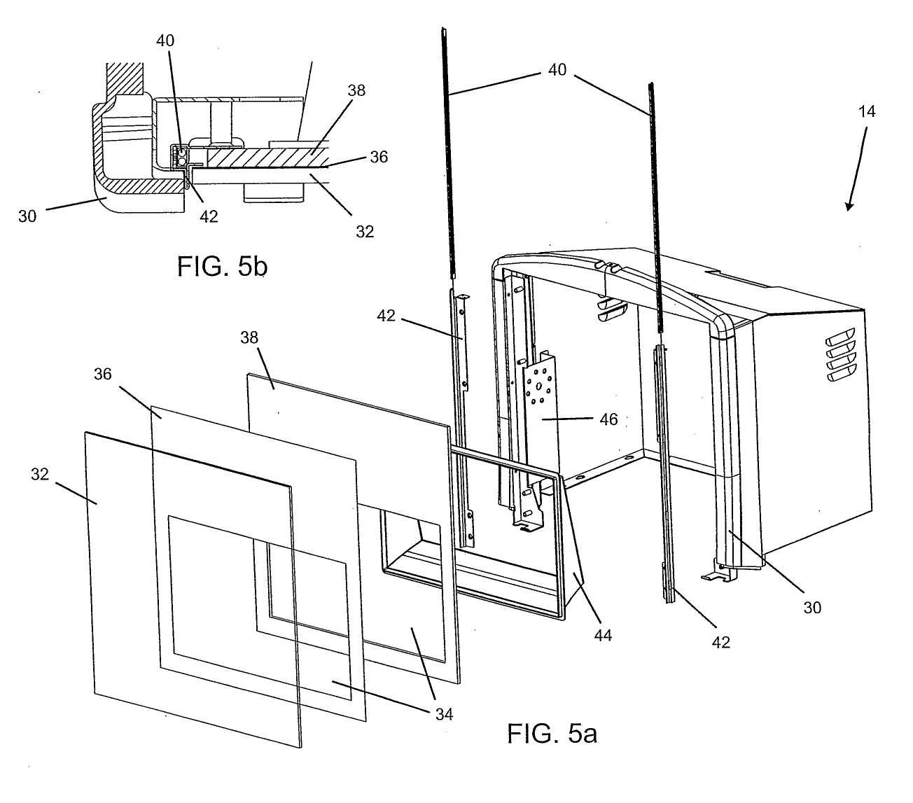

FIG. 5a is an exploded perspective view of a top box assembly 14 with the top box light panel display incorporating a video display. A display support 46 for mounting a video display is coupled to crown 30 using screws or other attachment methods. Lamp brackets 42 are also coupled to crown 30 forward of the display support 46. Lamps 40 are positioned within lamp brackets 42 prior to securing the lamp brackets 42 to the crown 30. Display bezel 44 is coupled to a video display, the display support 46, or directly to the light panel 38. The display bezel 44 prevents transmission of light from the light panel 38 to the display. Light panel 38 is positioned within a recess in the crown 30. Art film 36 is positioned in front of light panel 38 and may be coupled to the light panel 38 by adhesive or other means in order to maintain its position. Display glass 32 is also positioned in a recess in crown 30 and secured when the gaming machine front door is secured. Lamps 40 may be of any type including incandescent, fluorescent, LED, cold cathode fluorescent lamp (CCFL), and others. A key feature presented in this example is the physical separation of the lamps 40 from the light panel 38 allowing the removal of the light panel 38 without the necessity of touching, disturbing, or removing the lamps 40. Safety is also addressed with this application since technicians will not have to touch the lamps 40 which may be hot.

FIG. 5b is a cross-section view, taken generally along lines 5b-5b in FIG. 3, showing the positioning of the lamp 40 in accordance to the light panel 38. Light from lamp 40, positioned in lamp bracket 42 and in proximity of the edge of light panel 38, is directed into light panel 38. A reflective backing 48 forces the light forward and through the art film 36, highlighting the artwork presented on the art film 36. The display glass 32 “sandwiches” the art film 36 between it and the light panel 38 keeping the art film 36 in position and free from dirt or contaminants. Lamp bracket 42 is secured to crown 30 using screws or other coupling methods.

FIGS. 5a and 5b also show how the top box assembly 14 may be accessed through the front opening by removing the display glass 32, the art film 36, and the light panel 38. With the lamps 40 positioned in the lamp brackets 42 and the lamp brackets 42 secured to the crown 30, the display glass 32, the art film 36, and the light panel 38 may be removed and replaced without touching or disturbing the lamps 40. The display glass 32 is positioned in a recess in the crown 30 and secured when the front door of the gaming machine is closed. The art film 36 and the light panel 38 are secured between the display glass 32 and flanges on the crown 30.

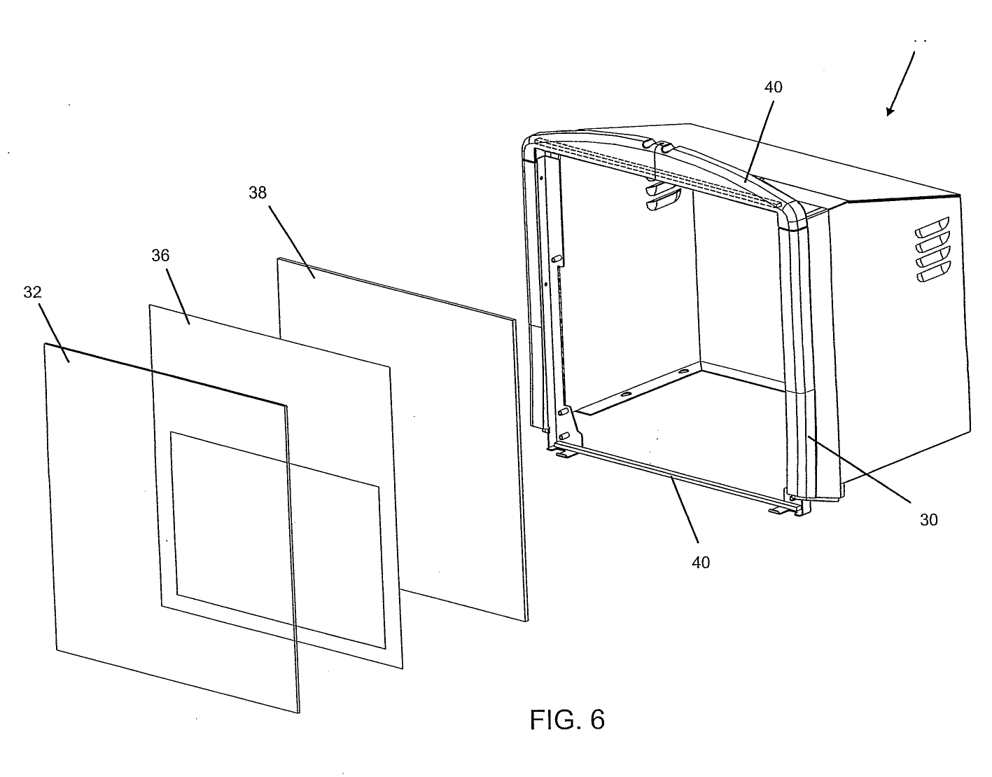

FIG. 6 is an exploded perspective view of an alternative lighting position for the top box light panel display. Lamp 40 is mounted on the top crown 30 of the top box assembly 14 display opening. When the light panel art film 36 and display glass 32 are positioned in the opening, the lamp 40 illuminates the light panel 38 from the top. Alternatively, lamp 40 may be mounted at the bottom of the top box assembly 14 opening. In some applications, multiple lamps 40 would be required or could be used. It should be recognized by those with ordinary skill in the art that the amount of illumination required to properly light the display depends on a number of factors including size, required brightness, and method of illumination.

While the present invention has been described with reference to one or more particular embodiments, those skilled in the art will recognize that many changes may be made thereto without departing from the spirit and scope of the present invention.

For example, lamp brackets 42 can be manufactured from a variety of materials including sheet metal, plastic, and other material suited to supporting the lamps 42 and resistant to heat. Extruded plastic is the most versatile and cost effective due to the fact that lengths can be produced and cut to length as needed.

Another safety feature could be the use of shields over the lamps 40 that reduce the amount of heat that exists in close proximity to the lamps 40 and prevents debris and liquids from touching the lamps 40. Shield material should be clear to allow the light to transmit into the light panel 38.

Each of these embodiments and obvious variations thereof is contemplated as falling within the spirit and scope of the claimed invention, which is set forth in the following claims.

1. A lighting arrangement for a wagering game machine, the wagering game machine having an interior component, comprising:
a panel including an edge, the panel being removable to access the interior component; and
a lamp for transmitting light through at least a portion of the panel via the edge, the lamp being mounted to a mounting member in proximity to the edge, the lamp and the mounting member being free of physical connection to the panel such that the panel can be removed from the game machine without disconnecting the panel from the lamp or the mounting member.

2. The arrangement of claim 1, wherein the lamp is slidably mounted to the mounting member.

3. The arrangement of claim 1, further including a cabinet having a crown, the mounting member being attached to the crown.

4. The arrangement of claim 1, wherein the lamp is a cold cathode fluorescent light (CCFL).

5. The arrangement of claim 1, wherein the lamp is elongated, the elongated lamp being positioned along the edge.

6. The arrangement of claim 5, wherein the panel is rectangular, the rectangular panel including first and second opposing edges and a pair of opposing faces extending between the first and second edges, the elongated lamp being positioned along the first edge.

7. The arrangement of claim 6, further including a second elongated lamp positioned along the second edge, the second lamp being mounted to a second mounting member in proximity to the second edge, the second lamp and the second mounting member being free of connection to the panel such that the panel may be removed from the game machine without disconnecting the panel from the second lamp or the second mounting member.

8. The arrangement of claim 1, wherein the lamp is free of electrical connection to the panel.

9. The arrangement of claim 1, wherein the mounting member is comprised of sheet metal or extruded plastic.

10. The arrangement of claim 1, further including a shield mounted between the lamp and the edge.

11. The arrangement of claim 1, wherein the panel includes an opening, further including a bezel along a perimeter of the opening, the bezel blocking the light from being transmitted into the opening.

12. A lighting arrangement for a wagering game machine, the wagering game machine having an interior component, comprising:
a panel including an edge, the panel being removable to access the interior component; and
a lamp for illuminating at least a portion of the panel by emitting light through the edge, the lamp being positioned along the edge but not being mounted to the panel such that the panel can be freely moved relative to the lamp.

13. The arrangement of claim 12, wherein the lamp is slidably mounted to a mounting member in proximity to the edge.

14. The arrangement of claim 13, wherein the mounting member is comprised of sheet metal or extruded plastic.

15. The arrangement of claim 12, wherein the lamp is a cold cathode fluorescent light (CCFL).

16. The arrangement of claim 12, wherein the lamp is elongated.

17. The arrangement of claim 16, wherein the panel is rectangular, the rectangular panel including first and second opposing edges and a pair of opposing faces extending between the first and second edges, the elongated lamp being positioned along the first edge.

18. The arrangement of claim 17, further including a second elongated lamp positioned along the second edge but not being mounted to the panel such that the panel can be freely moved relative to the second lamp.

19. The arrangement of claim 12, wherein the lamp is free of electrical connection to the panel.

20. The arrangement of claim 12, further including a shield mounted between the lamp and the edge.

21. The arrangement of claim 12, wherein the panel includes an opening, further including a bezel along a perimeter of the opening, the bezel blocking the light from being transmitted into the opening.

22. A method of servicing a wagering game machine, the machine including a panel and a lamp for illuminating at least a portion of the panel by emitting light through an edge thereof, the lamp being positioned along the edge but not being mounted to the panel, the method comprising:
removing the panel from the machine, without having to disconnect the panel from the lamp, to gain access to an interior component located behind the panel; and
inserting the same or a different panel into the machine without having to connect the same or the different panel to the lamp.

23. The method of claim 22, wherein the lamp is slidably mounted to a mounting member in proximity to the edge, further including removing the lamp from the mounting member and slidably mounting a new lamp to the mounting member.

24. The method of claim 23, wherein the lamp is elongated.

25. The method of claim 22, further including servicing the machine between the removing and inserting steps.

26. The method of claim 25, wherein the servicing step includes servicing the interior component.

27. The method of claim 22, wherein the inserting step inserts the different panel such that the machine is operable to play a new game.

28. A wagering game machine, comprising:
a cabinet including a crown in proximity to an upper end thereof;
an interior component;
a panel including an edge, the panel being removable to access the interior component;
a mounting member mounted to the crown in proximity to the edge; and
an elongated lamp for illuminating at least a portion of the panel by emitting light through the edge, the lamp being mounted to the mounting member, the lamp being positioned along the edge but not being mounted to the panel such that the panel can be freely moved relative to the lamp.
